(19) United States
(12) Patent Application Publication
(10) Pub. No.: US 2006/0098739 A1
(43) Pub. Date: May 11, 2006

(54) Video frame encoder driven by repeat decisions

(75) Inventor: Elliot N. Linzer, Suffern, NY (US)

Correspondence Address: LSI LOGIC CORPORATION, 1621 BARBER LANE, MS: D-106, MILPITAS, CA, 95035, US

(73) Assignee: LSI LOGIC CORPORATION

(21) Appl. No.: 10/984,243

(22) Filed: Nov. 9, 2004

(51) Int. Cl. H04N 11/02; H04N 7/12; H04N 11/04; H04B 1/66

(52) U.S. Cl. 375/240.16; 375/240.12; 375/240.24

(57) ABSTRACT

A method for encoding video, comprising the steps of: (A) detecting repeated fields in a video sequence and (B) determining a distance between reference frames based upon detection of the repeated fields.

### FIELD OF THE INVENTION

The present invention relates to film to video conversion generally and, more particularly, to a video frame encoder driven by repeat decisions.

### BACKGROUND OF THE INVENTION

Pre-recorded and recordable DVDs use MPEG-2 compression. Due to the limited storage capacity on a disk, it is desirable to obtain as efficient a compression ratio as possible at a given quality level. Increasing the compression ratio allows a single disk to store more video and/or store video at a higher quality level.

It would be desirable to implement a method and/or apparatus for increasing the compression ratio that does not set repeat_first_field and maintains top_field_first=1 in all pictures.

### SUMMARY OF THE INVENTION

The present invention concerns a method for encoding video, comprising the steps of: (A) detecting repeated fields in a video sequence and (B) determining a distance between reference frames based upon detection of the repeated fields.

The objects, features and advantages of the present invention include providing a method and/or apparatus for video frame encoding driven by repeat decisions that may (i) detect a telecine pattern, (ii) modify a distance between reference frames based on the detected telecine pattern, (iii) create a stream with fewer compression artifacts than conventional encoders, (iv) leave repeat_first_field=0 in all pictures, (v) maintain top_field_first=1 in all pictures, (vi) be implemented in DVD recorders, (vii) provide coding gain for film material similar to setting repeat_first_field=1 and/or (viii) provide better quality while maintaining repeat_first_field=0 and top_field_first=1.

### BRIEF DESCRIPTION OF THE DRAWINGS

These and other objects, features and advantages of the present invention will be apparent from the following detailed description and the appended claims and drawings in which:

FIG. 1 is a block diagram illustrating a number of film frames;

FIG. 2 is a block diagram illustrating an interlaced video frame;

FIG. 3 is a diagram illustrating a telecine conversion scheme;

FIG. 4 is a block diagram illustrating a group of pictures;

FIG. 5 is a block diagram illustrating a video encoder in accordance with the present invention;

FIG. 6 is a flow diagram illustrating an encoding process in accordance with a preferred embodiment of the present invention;

FIG. 7 is a timing diagram illustrating a number of frames encoded in accordance with the process of illustrated in FIG. 6;

FIG. 8 is a flow diagram illustrating an encoding process in accordance with another preferred embodiment of the present invention;

FIG. 9 is a diagram illustrating a number of frames encoded in accordance with the process of illustrated in FIG. 8; and

FIG. 10 is a diagram illustrating an example of a number of frames encoded as P-pictures.

### DETAILED DESCRIPTION OF THE PREFERRED EMBODIMENTS

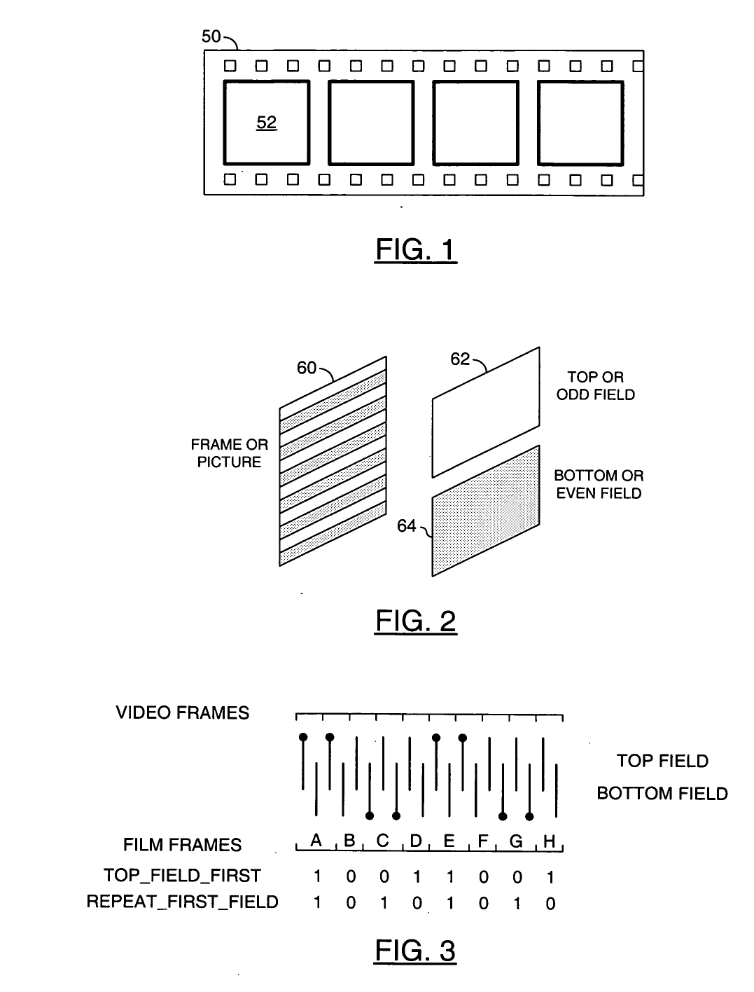

Referring to FIG. 1, a block diagram of a 35 mm film negative 50 is shown illustrating a number of film frames 52. Movies are usually made on 35 mm film. The 35 mm film format presents images (frames) at a rate of 24 frames per second (fps). The frames 52 are the smallest picture unit of the 35 mm film format.

Movies in the 35 mm film format may be converted to video format for distribution on DVDs. One video format used is NTSC interlaced video. Interlaced video is a field-based format that presents images (or pictures) at a rate of approximately 60 fields per second. A field is the smallest picture unit in the interlaced video format. A video frame is made up of two video fields. Thus, the interlaced video format has a frame rate of approximately 30 frames per second (fps).

Referring to FIG. 2, a diagram illustrating an interlaced video frame 60 is shown. Each interlaced video image (or picture) 60 includes a top (or odd) field 62 and a bottom (or even) field 64. For interlaced sequences, the two fields may be encoded together as a frame picture. Alternatively, the two fields may be encoded separately as two field pictures. Both frame pictures and field pictures may be used together in a single interlaced sequence. High detail and limited motion generally favors frame picture encoding. In general, field pictures occur in pairs (e.g., top/bottom, odd/even, field1/field2).

A field picture contains data from a single video field. For example, for video which has a resolution of 720×480 luminance (luma or Y) samples/frame, a single field picture would encode 720×240 luma samples (and 360×120 each for blue chrominance (Cb) and red chrominance (Cr) samples for 4:2:0 compression). The field picture may be divided into groups of samples called macroblocks. In one example, each macroblock may contain 16×16 luma samples and 8×8 chroma samples for each of Cb and Cr from the field. The MPEG-2 specification specifies that field pictures be coded in pairs (i.e., a top field and a bottom field with the same temporal reference or frame number).

A frame picture contains data from each of the two video fields. For example, for video which has a resolution of 720×480 luminance samples/frame, a single frame picture would encode 720×240 luma samples and 360×120 samples for each of Cb and Cr (for 4:2:0 compression) from each field. Since a frame is two fields, 720×480 luma samples and 360×240 each of Cb and Cr samples (for 4:2:0 compression) would be encoded overall. The frame picture may be divided into groups of samples called macroblocks. In one example, each macroblock may contain 16×16 luma samples and 8×8 chroma samples for each of Cb and Cr from the frame, or 16×8 luma and 8×4 for each of Cb and Cr from each field.

To match the frame (or picture) rates between 35 mm film format and NTSC interlaced video format, a conversion from the film format to the NTSC video format may be performed using a process referred to as telecine or 3:2 pulldown. The telecine conversion process involves expanding the 24 frames in the 35 mm film format by six frames to obtain the 30 frame per second NTSC video format.

The six frames that are added (or repeated) are determined based on a standardization of the telecine conversion. Since a video frame consists of two fields, the film format may be converted into fields first so that the smallest unit of both the film format and the video format are the same. Thus, the 35 mm film format becomes 48 fields. The field-based film material is then telecined into the NTSC video format.

Referring to FIG. 3, a diagram illustrating a telecine conversion scheme is shown. The telecine process involves repeating a first field of a film frame in a 2:3 sequence (repeated fields are indicated in FIG. 3 by a filled circle). Specifically, for film frames labeled A, B, C, D, E, F, G and H, the sequence of video fields may be described with reference to the film frames as follows: A top, A bottom, A top, B bottom, B top, C bottom, C top, C bottom, D top, D bottom, etc. Since one video frame consists of two video fields, the sequence of fields for the video frames becomes A top, A bottom; A top, B bottom;, B top, C bottom; C top, C bottom; D top, D bottom; etc. The conversion from four solid film frames 52 into five video frames 60 includes three solid frames (e.g., top and bottom fields from the same film frame) and two composite frames (e.g., top and bottom fields from different film frames).

In an MPEG-2 video, storing the frames for one second of a 30 fps video sequence creates a much bigger file than storing the 24 frames for one second of a 24 fps movie sequence. For example, one second at 24 frames per second is 20 percent smaller in size than one second at 30 frames per second. MPEG-2 includes two flags (e.g., repeat_first_field and top_field_first) that allow saving a movie in the 30 fps video format in the original 24 fps size.

The two flags top_field_first and repeat_first_field can be used to control how a frame picture is displayed. When the flag top_field_first is set (e.g., a logic HIGH or 1), the top field of the picture is displayed before the bottom field. When the flag top_field_first is not set (e.g., a logic LOW or 0), the bottom field is displayed first. When the flag repeat_first_field is set (e.g., a logic HIGH or 1), the first field, which can be top or bottom based on the flag top_field_first being set or not set, is displayed both before the second field and after the second field.

The flag repeat_first_field is usually used to encode mixed 24 frame per second (fps) film and 30 fps video material. Typically, when 24 fps film is converted to video, the first field of every other film frame is repeated. Thus two film frames, which occupy 2/24= 1/12th of a second, are displayed as five video fields, which also occupy 5/60= 1/12th of a second.

Conventional video encoders can detect the repeated fields. When a repeated field is detected, the repeated field is not compressed or transmitted. Instead, the flag repeat_first_field is set to one in the previous frame (in display order). The value of the flag top_field_first then changes in the next frame. The MPEG-2 specification specifies that the flag top_field_first change when and only when the flag repeat_first_field=1.

However, using the flag repeat_first_field in recordable DVDs has disadvantages. The DVD standard specifies that groups of pictures (GOPS) begin as top field first. Ensuring that the next GOP will start top field first is difficult when the flag repeat_first_field is set. Conventional recordable DVD video editors cannot handle a splice from the flag top_field_first=0 to the flag top_field_first=1 or from the flag top_field_first=1 to the flag top_field_first=0. Conventional recorders always set the flag top_field_first to 1.

In practice, conventional video encoders used with DVD recorders neither detect repeated fields nor set the flag top_field_first=0 in encoded video. The lack of either (i) detection of repeated frames or (ii) use of the flag top_field_first in the encoded video reduces video quality in two ways. First, more data needs to be represented in the compressed stream because 30 frames, instead of 24, are compressed every second. Therefore, for a given overall bit rate the number of bits/frame must be lower because repeated fields are compressed instead of setting the flag repeat_first_field. Second, some compressed frames contain data from two film frames. When compressed frames contain data from two film frames, the two fields of the compressed frame can be very different from one another when there is fast motion. Fields that are very different from one another can result in poor compression.

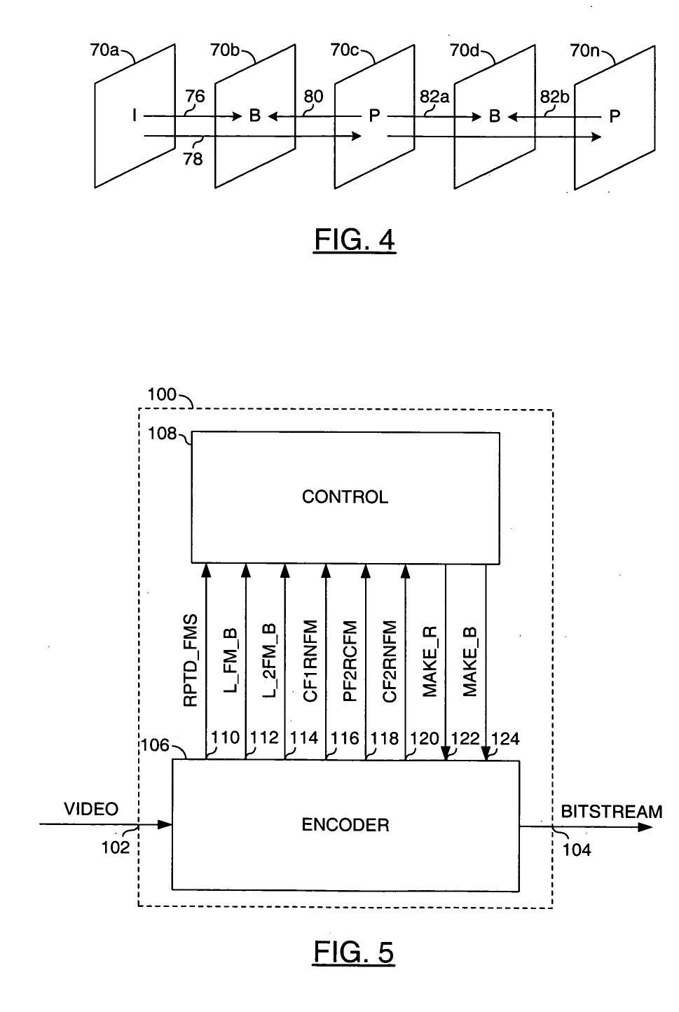

Referring to FIG. 4, a block diagram illustrating a series of pictures is shown. A data stream (e.g., a video stream) may comprise a series of pictures 70a-n. The pictures may also be referred to as images, frames, a group of pictures (GOP) or a sequence. The pictures generally comprise contiguous rectangular arrays of pixels (i.e., picture elements). Compression of digital video without significant quality degradation is usually possible because video sequences contain a high degree of: 1) spatial redundancy, due to the correlation between neighboring pixels, 2) spectral redundancy, due to correlation among the color components, 3) temporal redundancy, due to correlation between video frames, and 4) psycho-visual redundancy, due to properties of the human visual system (HVS).

Video frames generally comprise three rectangular matrices of pixel data representing a luminance signal (e.g., luma Y) and two chrominance signals (e.g., chroma Cb and Cr) that correspond to a decomposed representation of the three primary colors (e.g., Red, Green and Blue) associated with each picture element. The most common format used in video compression standards is eight bits and 4:2:0 sub-sampling (e.g., the two chroma components are reduced to one-half the vertical and horizontal resolution of the luma component). However, other formats may be implemented to meet the design criteria of a particular application.

An encoder may be configured to generate the series of encoded pictures 70a-n in response to a number of source pictures. The encoder may be configured to generate the encoded pictures 70a-n using a compression standard (e.g., MPEG-2, MPEG-4, H.264, etc.). In general, encoded pictures may be classified (or designated) as intra coded pictures (I), predicted pictures (P) and bi-predictive pictures (B). Intra coded pictures are generally coded without temporal prediction. Rather, intra coded pictures use spatial prediction within the same picture. For example, an intra coded picture is generally coded using information within the corresponding source picture (e.g., compression using spatial redundancy). An intra coded picture is generally used to provide a receiver with a starting point or reference for prediction. In one example, intra coded pictures may be used after a channel change and to recover from errors.

Predicted pictures (e.g., P-pictures or P-frames) and bi-predictive pictures (e.g., B-pictures or B-frames) may be referred to as inter coded. Inter coding techniques are generally applied for motion estimation and/or motion compensation (e.g., compression using temporal redundancy). P-pictures and B-pictures may be coded with forward prediction from references comprising previous I and P pictures. For example, the B-picture 70b and the P-picture 70c may be predicted using the I-picture 70a (e.g., as indicated by the arrows 76 and 78, respectively). The B-pictures may also be coded with (i) backward prediction from a next I or P-reference picture (e.g., the arrow 80) or (ii) interpolated prediction from both past and future I or P-references (e.g., the arrows 82a and 82b, respectively). However, portions of P and B-pictures may also be intra coded or skipped (e.g., not sent at all). When a portion of a picture is skipped, the decoder generally uses the associated reference picture to reconstruct the skipped portion with no error. In one example, a B-frame may differ from a P-frame in that a B-frame may do interpolated prediction from any two reference frames. Both reference frames may be (i) forward in time, (ii) backward in time, or (iii) one in each direction.

Referring to FIG. 5, a block diagram of a circuit 100 is shown in accordance with a preferred embodiment of the present invention. The circuit 100 may be implemented as a video encoder. The present invention may provide a video encoder configured to modify a distance between reference frames based on a detected telecine pattern. An encoder implemented in accordance with the present invention may generate a compressed bit stream with fewer compression artifacts than conventional encoders. For example, the encoder may be configured to modify the number of B-pictures between reference frames based on repeat field information.

The circuit 100 may be configured to encode video using one or more compression standards (e.g., MPEG-2, MPEG-4, H.263, H.264, etc.). The circuit 100 may have an input 102 that may receive an uncompressed video stream (e.g., VIDEO) and an output 104 that may present a compressed bit stream (e.g., BITSTREAM). In one example, the signal VIDEO may comprise video fields telecined from 24 fps film format. The circuit 100 is generally configured to generate the compressed bit stream BITSTREAM having a distance between reference frames determined in response to a telecine pattern of the uncompressed video stream VIDEO. In one example, the compressed bit stream BITSTREAM may be recorded (or stored) using an optical disc recorder and/or hard disk (e.g., personal video recorder (PVR)). In another example, the compressed bit stream BITSTREAM may be recorded for editing using a personal computer (PC) or other consumer electronics device. The compressed bit stream BITSTREAM may also be communicated by a transport stream to a transmission medium comprising over-the-air (OTA) broadcast, cable, satellite, network or any other medium implemented to carry, transfer and/or store a compressed bit stream.

The compressed bit stream BITSTREAM may comprise information (e.g., meta-data, picture user data, private data, etc.) configured to signal editors and decoders that a picture is a repeat and may be dropped. In one example, the information concerning repeated frames may be communicated by the circuit 100 using a tunneling method as described in a co-pending application U.S. Ser. No. 10,939,786, filed Sep. 13, 2004, which is hereby incorporated by reference in its entirety.

The circuit 100 may comprise, in one example, a circuit 106 and a circuit 108. The circuit 106 may be implemented, in one example, as an encoder circuit (or block). The circuit 108 may be implemented, in one example, as a control circuit (or block). The circuit 106 may have an input that may receive the signal VIDEO and an output that may present the signal BITSTREAM. The circuit 106 may be configured to present a number of signals that may convey information regarding fields in the uncompressed video stream VIDEO and frames in the compressed bit stream BITSTREAM.

In one example, the circuit 106 may have an output 110 that may present a signal (e.g., RPTD_FMS), an output 112 that may present a signal (e.g., L_FM_B), an output 114 that may present a signal (e.g., L_{—}2FM_B), an output 116 that may present a signal (e.g., CF1RNFM), an output 118 that may present a signal (e.g., PF2RCFM), an output 120 that may present a signal (e.g., CF2RNFM), an input 122 that may receive a signal (e.g., MAKE_B) and an input 124 that may receive a signal (e.g., MAKE_R). The signal RPTD_FMS may be configured indicate the presence (or detection) of repeated fields (e.g., a telecine pattern) within the uncompressed video stream VIDEO. The signal L_FM_B may be implemented to indicate whether a last frame was a B-frame. The signal L_{—}2FM_B may be implemented to indicate whether the last two frames were B-frames. The signal CF1RNFM may be implemented to indicate whether the current first field is repeated in a next frame. The signal PF2RCFM may be implemented to indicate whether a second field of a previous frame is repeated in the current frame. The signal CF2RNFM may be implemented to indicate whether a second field of the current frame is repeated in the next frame.

The circuit 106 may be configured to make encoding decisions in response to the signals MAKE_B and MAKE_R. In one example, when the signal MAKE_B is asserted, the circuit 106 may be configured to encode a current frame as a bi-predictive frame (e.g., a B-picture). When the signal MAKE_R is asserted, the circuit 106 may be configured to encode the current frame as a reference frame (e.g., an I-picture or a P-picture).

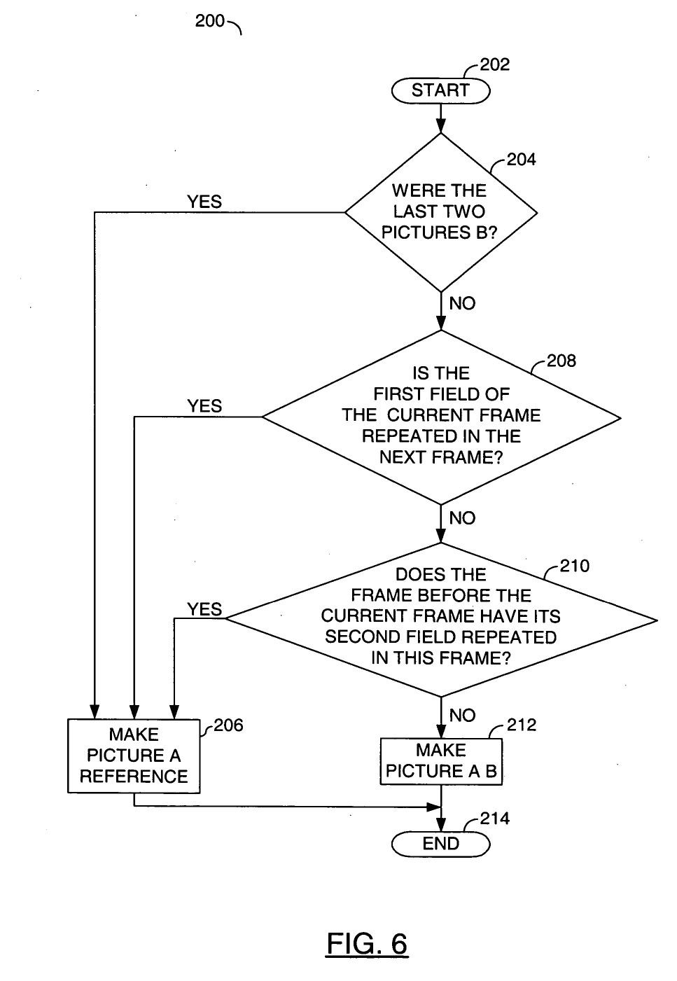

The circuit 108 may have a number of inputs that may receive the signals RPTD_FMS, L_FM_B, L_{—}2FM_B, CF1RNFM, PF2RCFM, and CF2RNFM. The circuit 108 may be configured to generate the signals MAKE_B and MAKE_R in response to the signals RPTD_FMS, L_FM_B, L_{—}2FM_B, CF1RNFM, PF2RCFM, and CF2RNFM. For example, the circuit 108 may be configured to implement processes as described below in connection with FIGS. 6 and 8.

The present invention generally (i) detects repeated fields, (ii) modifies an inter-reference-frame-distance (hereafter “M”) based on the repeated fields in a way that improves video quality, (iii) does not set the flag repeat_first_field=1 in any pictures, and (iv) maintains the flag top_field_first=1 in all pictures. Conventional methods may be used for detecting repeated fields. In one example, the present invention may vary the inter-reference-frame-distance M between 2 and 3. In another example, the present invention may vary the inter-reference-frame-distance M between 1 and 2.

Referring to FIG. 6, a flow diagram of a process 200 is shown illustrating an encoding process in accordance with a preferred embodiment of the present invention. In a first embodiment of the present invention, the value of “M” is generally set to 3 for video (non-film) material and (when in a regular pattern) varied between 2 and 3 for film material. The frames are generally processed in display (or capture) order. The process 200 may be used to determine a type or designation (e.g., reference or B) for the “current” picture.

The process 200 may comprise, in one example, a state 202, a state 204, a state 206, a state 208, a state 210, a state 212 and a state 214. The process 200 generally starts once the video sequence is ready to be encoded (e.g., the state 202). Pictures (or frames) may be examined to determine whether the last two pictures were designated as B pictures (e.g., the state 204). When the last two pictures were designated as B pictures, the process 200 generally moves to the state 206. In the state 206, the current picture is designated as a reference picture. When the last two pictures were not designated as B pictures, the process 200 generally moves to the state 208. In the state 208, the first field of the current frame is examined to determine whether the first field is repeated in the next frame. When the first field of the current frame is repeated in the next frame, the process 200 moves to the state 206 and the current frame is designated as a reference picture. When the first field of the current frame is not repeated in the next frame, the process 200 generally moves to the state 210. In the state 210, a frame before the current frame is examined to determine whether a second field of the previous frame is repeated in the current frame. When the second field of the previous frame is repeated in the current frame, the process 200 generally moves to the state 206 and the current frame is designated as a reference picture. When the second field of the frame before the current frame is not repeated in the current frame, the current frame is designated as a B picture (e.g., the state 212). Once the type of current frame has been designated, the process 200 may end (e.g., the state 214).

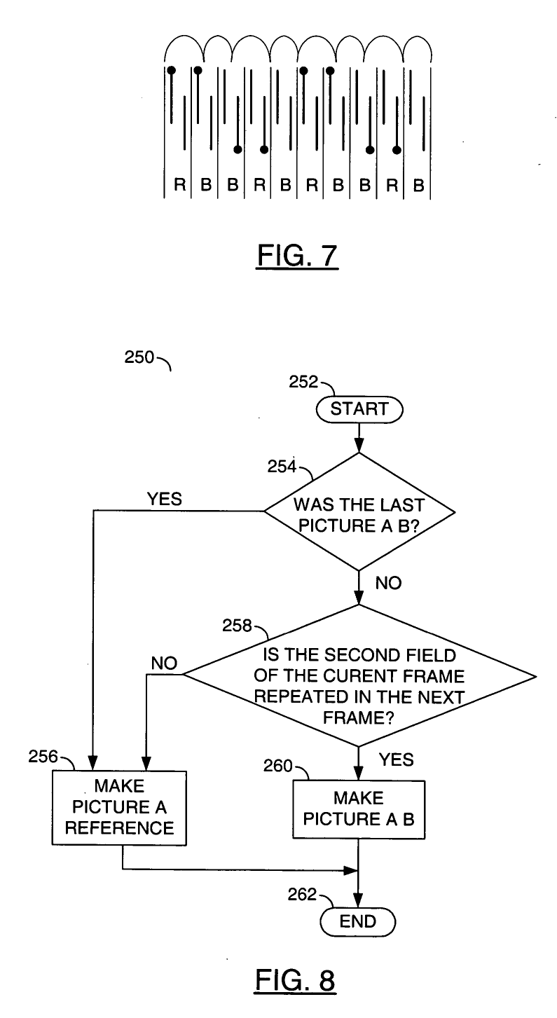

Referring to FIG. 7, an example of film material where M is determined according to the process of FIG. 6 is shown. In FIG. 7, encoded frames are separated by straight vertical lines. Each B-frame is indicated by a “B” and each reference frame is indicated by an “R”. The curved lines on the top of the diagram generally delineate which fields are from a common film frame.

Referring to FIG. 8, a flow diagram of a process 250 is shown illustrating an encoding scheme in accordance with a second embodiment of the present invention. In one example, the value of “M” may 1 for video (non-film) material and (when in a regular pattern) varied between 1 and 2 for film material. The frames are generally processed in display (or capture) order. The process 250 may be used to determine the type or designation (e.g., reference or B) for the “current” picture.

The process 250 may comprise, in one example, a state 252, a state 254, a state 256, a state 258, a state 260 and a state 262. When the type of a current frame is to be determined, the process 250 may be entered (e.g., the state 252). The process 250 generally moves to a state 254. In the state 254, pictures (or frames) may be examined to determine whether the last frame was designated a B frame. When the last picture was designated a B frame, the current frame is designated as a reference frame (e.g., the state 256). When the last frame was not designated as a B picture, the process 250 generally moves to a state 258. In the state 258, the process 250 may examine whether a second field of the current frame is repeated in the next frame. When the second field of the current frame is not repeated in the next frame, the current frame is designated as a reference frame (e.g., the state 256). When the second field of the current frame is repeated in the next frame, the current frame is designated as a B picture (e.g., the state 260). Once the frame type for the current frame has been determined, the process 250 may move to a state 262, where the process 250 may end.

The designation of the frame types (e.g., using either the process 200 or the process 250 above) is generally performed in display (or capture) order. For example, displayed (or captured) frames may be designated, in one example, as follows:
R0 B1 B2 R3 . . .
The designation of frame types is generally performed prior to encoding because in order to determine the type of a current frame (e.g., frame 3) the types of one or more previous frames (e.g., frames 1 and 2) are examined. However, the order in which the frames are encoded (decoded) and placed (appear) in the bit stream may be different from the display or capture order. For example, when the frames B1 and B2 depend on the frame R3, the frame R3 is generally encoded (decoded) and placed (appears) in the bit stream before the frames B1 and B2.

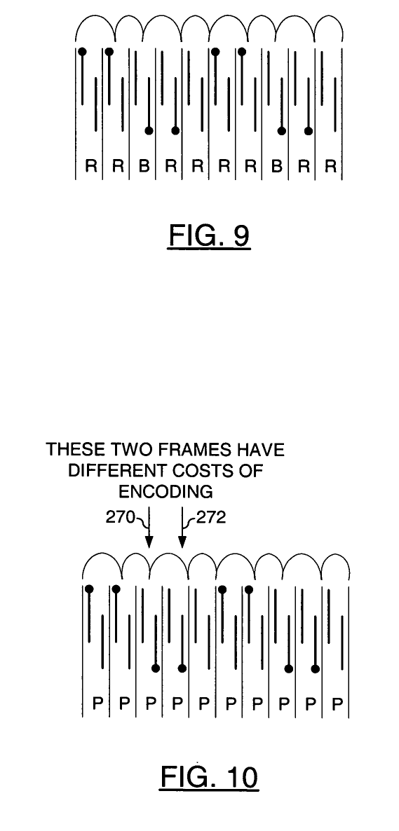

Referring to FIG. 9, a diagram is shown illustrating an example of film material where M is determined according to the process of FIG. 8. In FIG. 9, encoded frames are shown separated by straight vertical lines. Each B-frame is indicated by a “B” and each reference frame is indicated by an “R”. The curved lines on the top of the diagram generally delineate which fields are from a common film frame.

In general, the embodiments of the present invention described in connection with FIGS. 6 and 8 share the following properties: (1) For every pair of fields that are repeats of one another, one of the fields may be motion compensated (or predicted) from the other; (2) For every pair of fields that are repeats of one another, the field that cannot be motion compensated from the other is encoded in a frame with another field from the same film frame. With respect to the first property above, one of the following is generally true: (a) one of the fields in the pair of fields is in a B-picture and the other field is in a reference picture just before or just after the B-picture; (b) one of the fields in the pair of fields is in a first reference picture and the other field is in a second reference picture immediately preceding the first reference picture.

Applying the first property, while 30 frames (60 fields) are nominally encoded every second, 12 fields of the 60 are repeats of other fields and may be motion compensated. The motion compensated fields may be encoded using very few bits. Applying the second property, frames that are encoded as three fields, where one field of the three fields is motion compensated from another field of the three fields, have two fields that are not motion compensated from other fields. The two fields that are not motion compensated comprise two fields from the same film frame. Frames with fields from the same film frame may compress more easily than frames with fields from two film frames.

Referring to FIG. 10, a diagram is shown illustrating a sequence of frames encoded as P-pictures. Since all pictures are encoded as P-pictures, every repeated field may be motion compensated from a copy of the same field in the previous frame in accordance with the first property described above. However, there are instances where the second property described above may not be satisfied.

For example, the following discussion is with reference to the two frames to which the arrows 270 and 272 point in FIG. 10. In the first frame (e.g., pointed to by the arrow 270), both fields are independently coded; neither is a repeat of a field that can be used as a reference for the first frame. Also, the fields are from different film frames. The cost of encoding the first frame is the “cost of encoding two fields from different film frames as one frame”.

In the second frame (e.g., pointed to by the arrow 272), the first field is independently coded; the first field is not a repeat of a field that can be used as a reference for the second frame. The second field is essentially “free” (e.g., the second field is a repeat of a field that may be used as a reference for the second frame). The cost of encoding the second frame is the “cost of encoding a frame where one field is essentially free”.

In general, coding of the same two frames (e.g., the frames pointed to by the arrows 270 and 272 in FIG. 10) may be improved using the variable reference frame spacing in accordance with the present invention (e.g., as illustrated in FIG. 7 (M=2, 3) or FIG. 9 (M=1, 2)). For example, in the first frame (e.g., a B-picture), the first field is independently coded; the first field is not a repeat of a field that can be used as a reference for the second frame. The second field is essentially “free.” For example, the second field is a repeat of a field that can be used as a reference for the first frame (e.g., the reference picture that follows). The cost of encoding the first frame is the “cost of encoding a frame where one field is essentially free.”

In the second frame (e.g., a reference picture), both fields are independently coded; neither is a repeat of a field that can be used as a reference for the second frame. However, both fields are from the same film frame. Since both fields are from the same film frame, the cost of encoding the second frame is the “cost of encoding two fields from the same film frame as one frame”.

In general, when M=1 (e.g., FIG. 10), the first property (described above in connection with FIG. 9) is generally met. However, the pair of frames (pointed to by the arrows 270 and 272 in FIG. 10) may be encoded more easily (e.g., with less cost) by implementing a variable inter-reference-frame-distance M in accordance with the preferred embodiments of the present invention (e.g., FIGS. 7 and 9). For example, in both cases, one frame may be encoded at the cost of encoding a frame where one field is essentially free. When M=1, one frame is encoded at the cost of encoding two fields from different film frames as one frame. When a variable M in accordance with the present invention is implemented, one frame may be encoded at the cost of encoding two fields from the same film frame as one frame. Because the cost of encoding two fields from the same film frame as one frame is cheaper than the cost of encoding two fields from different film frames as one frame, the variable M method in accordance with the present invention generally provides an advantage over conventional methods. Other advantages of the present invention may include providing most of the coding gain for film material as may be obtained with setting the flag repeat_first_field=1, while maintaining the flag repeat_first_field=0 and the flag top_field_first=1 for applications involving optical disk recorders (e.g., DVD), hard disk recorders (e.g. personal video recorders (PVRs)), personal computers (PCs) and/or consumer electronics devices (e.g., configured for recording or editing applications).

The present invention may also provide optimized frame encoding when repeats are detected. The processes described above generally concern how to place reference frames such that (among other things) when two fields are copies of one another one field may be predicted (motion compensated) from the other field. Another aspect of the present invention concerns how to efficiently encode a frame when one of the fields may be predicted from the other copy of itself. For example, an encoder implemented in accordance with the present invention may be configured, in addition to the above processes, to determined how to efficiently encode a frame with a field that may be predicted from a copy of itself. Alternatively, an encoder implemented in accordance with the present invention may be configured to determined how to efficiently encode a frame any time there are two fields that are copies of one another such that one field can be predicted (motion compensated) from the other field. In general, even when one field is a “copy” of another (e.g., due to 3:2 pulldown (or telecine) conversion), the fields are generally not exact digital replicas of one another. For example, the fields may be different due to noise in the telecine process or later.

In one example, an encoder in accordance with a preferred embodiment of the present invention may be configured to use a zero motion vector for the field that is motion compensated from the copy of itself (e.g., the motion vector may be set to point to the other copy). The motion vector may also have the correct direction (forward or backward) and correct field parity (top or bottom) so that reference is made to the copy. In general, because the fields may not be exact copies of one another, a conventional motion estimation (ME) algorithm may not pick a vector similar to the vector generated by an encoder implemented in accordance with the present invention.

In another example, an encoder in accordance with a preferred embodiment of the present invention may be configured to set the residual to zero when a repeat is detected. In general, the residual for the field that is motion compensated from the copy of itself is set to zero. Setting the residual to zero may be done in a number of ways. For example, the residual may be set to zero (i) by modifying the sample residual (difference between original and motion compensated), (ii) by inputting “zeros” to the transform, (iii) by using a copy of the motion compensated field as the original or vice versa, (iv) by forcing the transform coefficients to zero, and/or (iv) any other appropriate method.

In yet another example, an encoder in accordance with a preferred embodiment of the present invention may be configured to use field pictures. When a frame is encoded where one of the fields may be predicted from the other copy of itself, the encoder may be configured to encode the frame as a pair of field pictures. A pair of field pictures is used because: when the motion vector is set zero (e.g., to point to the other copy), the macroblock mode for each field may be determined as forward or backward based on the position of the other copy of the field that can be motion compensated from a copy of itself. The same mode (e.g., forward or backward) is generally used for the other field as well. If field pictures are used, the other field may be independently selected as forward, backward, or interpolated.

When the encoder sets the residual to zero, the residual in one field is zero, but not in the other. For luma blocks, field DCT may be used so half the blocks are not coded. However, chroma blocks in a frame picture always use frame DCT. The chroma blocks may have one-half the lines—even or odd lines—with zero residual, but the other lines without. When frame pictures are used, all of the chroma blocks are generally one-half zero. However, when field pictures are used one-half of the chroma blocks (e.g., those in the field that is a copy) are generally zero. The latter is more desirable.

In still another example, an encoder in accordance with a preferred embodiment of the present invention may be configured to use all three of the above techniques (e.g., use a zero motion vector, set residuals to zero and use field pictures). For example, instead of actually encoding the field picture that is a repeat, a pre-generated bit stream fragment may be used for the field picture. A pre-generated bit stream fragment may be used because once all three of the above techniques are implemented, the content of the field picture is data independent. The advantage of using the fourth approach is that it may be simpler than implementing the first three aspects independently.

The present invention may include providing a method and/or apparatus for video frame encoding driven by repeat decisions that may (i) detect a telecine pattern, (ii) modify a distance between reference frames based on the detected telecine pattern, (iii) create a stream with fewer compression artifacts than conventional encoders, (iv) leave the flag repeat_first_field=0 in all pictures, (v) maintain the flag top_field_first=1 in all pictures, (vi) be implemented in DVD recorders, (vii) provide coding gain for film material similar to setting the flag repeat_first_field=1 and/or (viii) provide better quality while maintaining the flag repeat_first_field=0 and the flag top_field_first=1.

The functions performed by the flow diagrams of FIGS. 6 and 8 may be implemented using a conventional general purpose digital computer programmed according to the teachings of the present specification, as will be apparent to those skilled in the relevant art(s). Appropriate software coding can readily be prepared by skilled programmers based on the teachings of the present disclosure, as will also be apparent to those skilled in the relevant art(s).

The present invention may also be implemented by the preparation of ASICs, FPGAs, or by interconnecting an appropriate network of conventional component circuits, as is described herein, modifications of which will be readily apparent to those skilled in the art(s).

The present invention thus may also include a computer product which may be a storage medium including instructions which can be used to program a computer to perform a process in accordance with the present invention. The storage medium can include, but is not limited to, any type of disk including floppy disk, optical disk, CD-ROM, magneto-optical disks, ROMS, RAMs, EPROMs, EEPROMs, Flash memory, magnetic or optical cards, or any type of media suitable for storing electronic instructions.

While the invention has been particularly shown and described with reference to the preferred embodiments thereof, it will be understood by those skilled in the art that various changes in form and details may be made without departing from the spirit and scope of the invention.

1. A method for encoding video, comprising the steps of:
(A) detecting repeated fields in a video sequence; and
(B) determining a distance between reference frames based upon detection of said repeated fields.

2. The method according to claim 1, wherein said distance between two of said reference frames is configured such that a first field detected as a repeat of a second field is motion compensated from said second field.

3. The method according to claim 1, wherein said distance between said reference frames is configured such that for a first field and a second field that are detected as repeats of one another:
said first field is motion compensated from said second field; and
said second field is encoded in a frame comprising said second field and a third field from a film frame that produced said second field.

4. The method according to claim 1, further comprising the step of:
setting at least one motion vector to zero based upon detection of said repeated fields.

5. The method according to claim 1, further comprising the step of:
encoding a residual of at least one macroblock as zero based upon detection of said repeated fields.

6. The method according to claim 1, further comprising the step of:
encoding a first field that is a repeat of a second field as a field picture based upon detection of said repeated fields.

7. The method according to claim 1, further comprising the step of:
representing at least one picture with a pre-generated bit stream based upon detection of said repeated fields.

8. The method according to claim 1, further comprising the step of:
generating a transport stream comprising the encoded video.

9. The method according to claim 1, further comprising:
recording the encoded video to one or more devices selected from the group consisting of an optical disc recorder, a hard drive, a personal video recorder (PVR), a personal computer (PC), and any other consumer electronic devices configured to store or communicate encoded bit streams.

10. The method according to claim 9, wherein said personal computer and said consumer electronic devices are further configured for editing the encoded video.

11. The method according to claim 1, further comprising:
generating an encoded bit stream comprising information configured to signal whether an encoded picture is a repeat.

12. An apparatus comprising:
means for detecting repeated fields in a video sequence; and
means for determining a distance between reference frames based upon detection of said repeated fields.

13. An apparatus comprising:
a first circuit configured to detect repeated fields in a video sequence; and
a second circuit configured to determine a distance between reference frames used for encoding said video sequence based upon detection of said repeated fields.

14. The apparatus according to claim 13, wherein said distance between reference frames is variable when said repeated fields are detected.

15. The apparatus according to claim 14, wherein said distance between reference frames varies between a first value and a second value.

16. The apparatus according to claim 15, wherein said first value is one (1) and said second value is two (2).

17. The apparatus according to claim 15, wherein said first value is two (2) and said second value is three (3).

18. The apparatus according to claim 13, wherein said distance between reference frames is configured such that a first field detected as a repeat of a second field is motion compensated from said second field.

19. The apparatus according to claim 13, wherein said distance between reference frames is configured such that for a first field and a second field that are detected as repeats of one another:
said first field is motion compensated from said second field; and
said second field is encoded in a frame comprising said second field and a third field from a film frame that produced said second field.

20. The apparatus according to claim 13, wherein said first circuit is further configured to set at least one motion vector to zero based upon detection of said repeated fields.

21. The apparatus according to claim 13, wherein said first circuit is further configured to encode a residual of at least one macroblock as zero based upon detection of said repeated fields.

22. The apparatus according to claim 13, wherein said first circuit is further configured to encode a first field that is a repeat of a second field as a field picture based upon detection of said repeated fields.

23. The apparatus according to claim 13, wherein said first circuit is further configured to represent at least one picture with a pre-generated bit stream based upon detection of said repeated fields.

24. The apparatus according to claim 13, wherein said first circuit is further configured to (i) encode said video sequence and (ii) generate a transport stream comprising said encoded video sequence.

25. The apparatus according to claim 13, further comprising:
one or more devices selected from the group consisting of an optical disc recorder, a hard drive, a personal video recorder (PVR), a personal computer (PC), and any other consumer electronic devices configured to store or communicate encoded bit streams, wherein said one or more devices are configured to record said encoded video sequence.

26. The apparatus according to claim 25, wherein said personal computer and said consumer electronic devices are further configured for editing said encoded video sequence.

27. The apparatus according to claim 13, wherein said first circuit is further configured to generate an encoded bit stream comprising information configured to signal whether an encoded picture is a repeat.

28. A method for encoding video, comprising the steps of:
(A) detecting repeated fields in a video sequence; and
(B) based upon detection of said repeated fields, performing an operation selected from the group consisting of (i) setting at least one motion vector to zero, (ii) encoding a residual of at least one macroblock as zero, (iii) encoding a first field that is a repeat of a second field as a field picture and (iv) representing at least one picture with a pre-generated bit stream.

29. An apparatus comprising:
a first circuit configured to detect repeated fields in a video sequence; and
a second circuit configured to perform, based upon detection of said repeated fields, an operation selected from the group consisting of (i) setting at least one motion vector to zero, (ii) encoding a residual of at least one macroblock as zero, (iii) encoding a first field that is a repeat of a second field as a field picture and (iv) representing at least one picture with a pre-generated bit stream, based upon detection of said repeated fields.
